(19) United States
(12) Patent Application Publication
(10) Pub. No.: US 2011/0173040 A1
(43) Pub. Date: Jul. 14, 2011

(54) SYSTEMS AND METHODS FOR CUSTOMER ALLOCATION

(75) Inventors: Christopher Paul Curtis, North Vancouver (CA); Stuart Clifford McNeill, West Vancouver (CA)

(73) Assignee: Ultra Sales Technology Inc., North Vancouver (CA)

(21) Appl. No.: 12/685,978

(22) Filed: Jan. 12, 2010

(51) Int. Cl. G06Q 10/00; G06Q 50/00; G06F 17/30

(52) U.S. Cl. 705/7.13; 707/802; 707/E17.044

(57) ABSTRACT

Systems and methods for allocating customers to agents. Customer information is received from customers that contains characteristics about the customers. The customer information may be stored in a database. Agent information is stored in a database and contains caller conversion success profiles for the agents. The caller conversion success profiles contain information regarding an agents ability to perform with customers having certain characteristics.

### BACKGROUND

Generally, call centers provide customers with the ability to communicate with an agent regarding various products or services. In some situations, the customer is able to purchase a product or a service during the interaction with the agent. Customers may come in contact with the agents through various channels. For example, the customer may see an advertisement related to a product or service and dial an advertised telephone number in order to receive more information or make a purchase. That customer may reach a call center staffed with a large number of agents fielding customer calls. Additionally, the customer may complete a questionnaire or survey and indicate their interest in receiving more information or purchasing a product or service. An agent in a call center might receive contact information from the questionnaire and initiate a telephone call with the customer. During that call, the agent can provide the customer with information and sell the product or service to the customer.

Converting a conversation with a customer into an actual sale, or meeting other goals during the call, is desired for both the company offering the product/service and the agent communicating with the customer. The company is interested in a successful engagement with the customer, and the agent's performance and/or compensation may be at least partially based on that agent's ability to convert a conversation with a customer into a sale.

### SUMMARY OF THE INVENTION

In one general aspect, various embodiments of the present disclosure are directed to a systems and methods for increasing an agent's ability to convert a conversation or communication with a customer (a “lead”) into a sale, or have an otherwise successful interaction. In various embodiments, data regarding the customer, such as income level, occupation, geographic location, and interests, for example, are received by a computer system and may stored in a database. Additionally, data regarding individual agents' abilities to “convert” a customer based on various customer characteristics are also stored in a database. The computer system matches a customer to a particular agent based on the agent's proven success with customers having similar characteristics to the customer seeking the product or services.

### FIGURES

Various embodiments of the present invention are described herein by way of example in conjunction with the following figures wherein:

FIG. 1 is a schematic illustration of a call center according to one non-limiting embodiment.

FIG. 2 is a flow chart of a matching process according to one non-limiting embodiment.

FIG. 3 is a table comprising caller conversion success profiles in accordance with one non-limiting embodiment.

FIG. 4 is a schematic illustration of a call center according to another non-limiting embodiment.

### DETAILED DESCRIPTION OF THE INVENTION

Various non-limiting embodiments of the present disclosure will now be described to provide an overall understanding of the principles of the structure, function, manufacture, and use of the systems, apparatuses, accessories, and methods disclosed herein. One or more examples of these non-limiting embodiments are illustrated in the accompanying drawings. Those of ordinary skill in the art will understand that the systems, apparatuses, accessories, and methods specifically described herein and illustrated in the accompanying drawings are non-limiting example embodiments and that the scope of the various non-limiting embodiments of the present disclosure are defined solely by the claims. The features illustrated or described in connection with one non-limiting embodiment may be combined with the features of other non-limiting embodiments. Such modifications and variations are intended to be included within the scope of the present disclosure.

Embodiments of the present disclosure are described below generally for the purposes of illustration in the context of a call center where an agent is telephonically connected to a customer. As discussed in more detail below, the particular agent that is connected to a particular customer may be based on characteristics of the agent and characteristics of the customer. It should be recognized, however, that the embodiments are not limited to call center applications. As is to be appreciated, the agent allocation systems and methods described herein may be implemented in a variety of applications and environments. Thus, as used in the present disclosure, the use of the term “agent” is meant to include all persons who may be connected to another person, in a call center context or otherwise. Similarly, the use of the term “customer” is meant to include all persons who seek information, products, services, or otherwise.

In various implementations, the agent may be, for example, a call center agent. In other embodiments the agent may be a realtor and the customer may be a person seeking to purchase or sell real estate. Characteristics of the customer, such as where their property is located and income level, in addition to characteristics of the realtor may be used by the methods and systems described herein to match the customer to a particular realtor out of a pool of realtors, for example. A customer may, for example, contact a real estate company and be transferred to or otherwise connected to a mobile device associated with the realtor using the techniques described herein. In various implementations, the agent may be a mortgage broker and the customer may be a person seeking to enter into a mortgage. Characteristics of the customer and characteristics of each of the mortgage brokers in a pool of mortgage brokers may be used to match the customer to a particular mortgage brokers in a pool of realtors. Similarly, the agent may be an insurance agent, or even an insurance company, that is matched to a customer seeking insurance coverage, for example. Relevant characteristics of the customer may include insurance coverage sought and geographic location and relevant characteristics of the insurance provider may include the geographic locations where they are licensed.

Additionally, the systems and methods disclosed herein may be used in a variety of other sales applications, such as multi-level marketing platforms. This, in various embodiments, the agent may be a customer service representative, a technical support representative, a sales representative, a warranty provider, an academic advisor, a recruiter, or an attorney, for example. The embodiments presented herein are not limited to any particular service, product, or offering, but instead may be implemented across a number of varying applications, such as business services, consumer services, technical support services, travel services, and customer service support services, for example. It is intended that all such implementations are within the scope of this disclosure and the appended claims. Thus, while the disclosure below is provided generally in the context of a call center for illustration purposes, this disclosure is not so limited.

Embodiments of the present disclosure are directed to methods and systems for increasing a agent's ability to convert a conversation or communication with a customer (a “lead”) into a sale, including cross-sells and up-sales, or otherwise meet a goal during an engagement with a customer. In various embodiments, data regarding characteristics of the customer are received by the computer system and the data may be stored in a database. Additionally, individual agents' abilities to “convert” a customer based on customer characteristics are stored in a database. The system then matches a customer to a particular agent based on the agent's proven success with customers having similar characteristics to the customer placing the call. In some embodiments, incoming calls from customers are used, while in other embodiments outgoing calls to customers are used. The types of characteristics of the customer that are tracked and/or stored in the database may vary, with different customers having more or less available characteristics that may be analyzed by the computer system. In some embodiments, the customer characteristics (or “variables”) may comprise any combination of age, gender, income levels, geographic location, time of call, ethnicity, interests and/or affinities, occupation, education level, marital status, number of children, or number of grandchildren, for example. As is to be appreciated, this list of characteristics is not exhaustive and a wide variety of customer characteristics may be analyzed in order to match the customer with an appropriate agent. Additionally, the relevant characteristics may vary based on the particular application. For example, in a real estate or legal services context, geographic characteristics may be considered. As discussed in more detail below, an allocation algorithm may be employed by the computer system to match a customer with an appropriate agent.

Furthermore, in various embodiments, the goal of the interaction between the agent and the customer may not be necessarily to make a “purchase” or “sale” during the conversation. For example, in one embodiment, a goal of the interaction between the agent and the customer may be to schedule a follow-up meeting with a representative. In one embodiment, the goal of the interaction may be for the agent to provide customer service, technical support, financial advice, information, educational material, a demonstration, or provide other products/services, for example, to the customer. Accordingly, the present disclosure is not limited to any particular type of interaction and/or goal.

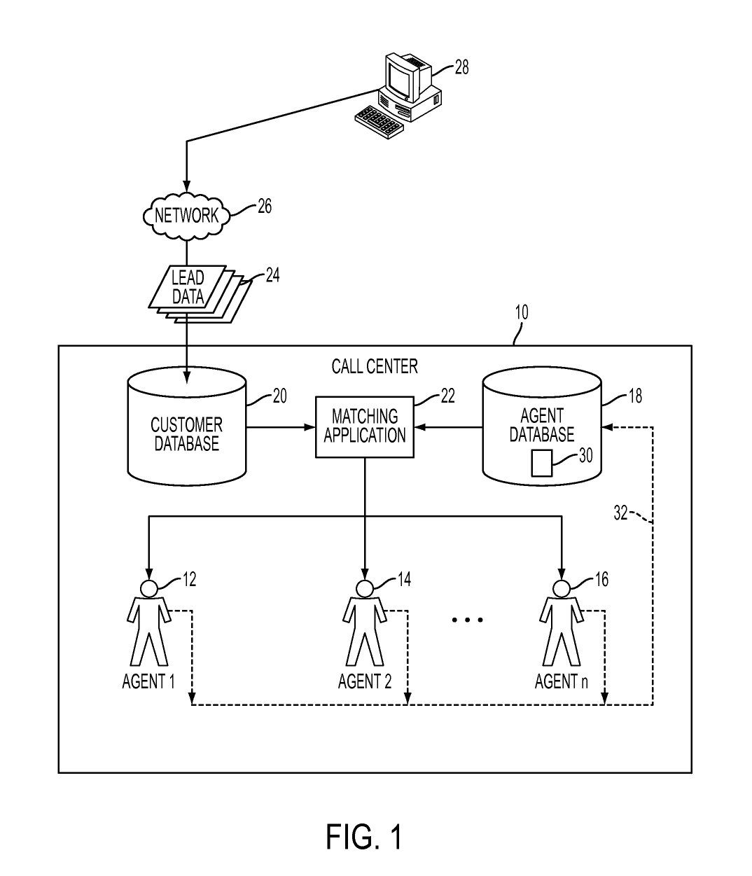

FIG. 1 is a schematic illustration of a call center according to one non-limiting embodiment. A call center 10 may comprise a plurality of human agents 12, 14, 16. Each agent 12, 14, 16 may be positioned at a station comprising the tools and equipment necessary to perform their call agent duties, such as an agent computer device and an agent telephone headset. While three agents are illustrated in FIG. 1, it is to be appreciated that a call center may comprise a greater or less number of agents, such two to one thousand, or more, for example. Furthermore, individual agents or groups of a agents may be located in remote locations and still be associated with the call center 10. For example, in some embodiments, the call center 10 may be a collection of agents that are each working from their home and/or satellite offices. The agents may have a network connection to the call center 10 in such cases.

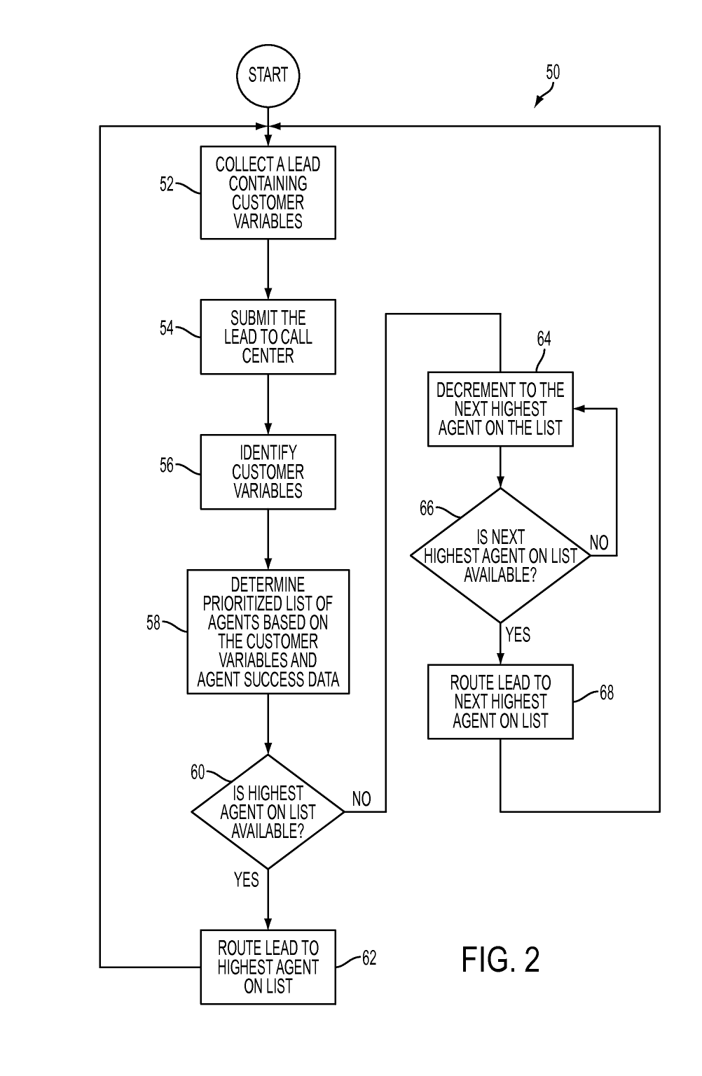

The call center 10 may further comprise an agent database 18 and a customer database 20. The call center 10 may also comprise a matching module 22. The matching module 22 may reside in a single computer system, or may be distributed across a number of computer systems and devices. As described in more detail below with reference to FIG. 2, the matching module 22 uses the data from the customer database 20 and the agent database 18 to match customers to the appropriate agent in the call center 10. The databases 18, 20 may be implemented as memory (e.g., ROM) and/or mass storage systems (such as hard disk drives) of the computer system(s) of the call center 10.

The customer database 20 may be populated with customer data 24. The customer data 24 may be transmitted to the call center 10 via any suitable technique, such as a network 26 connected to the call center 10. The customer data 24 may be, for example, information provided via questionnaires or surveys completed by customers wishing to seek more information about a product or service. This customer data may be supplied by a networked computer 28, by mail, by fax transmission, by e-mail, or any other available method. In one embodiment, the customer populates an HTML form that is presented on a webpage on the customer's computer 28. The form may request information regarding any number of characteristics of the customer, such as age, gender, income level, geographic location, ethnicity, interests, occupation, education level, marital status, number of children, or number of grandchildren, for example. In some embodiments, the form may only request the customer's name and telephone number, and other tools are then used to gather more information about the customer. In some embodiments, the customer's IP address may be queried to determine the geographic location of the customer. In addition, other data mining services may provide additional information about the customer based on their name, address, social security number, or other inputs. Any information gathered is considered the customer data 24 and may be stored in the customer database 20. In some embodiments, however, a customer database 20 may not need to be used. For example, in various implementations, a computer system implementing the matching module 22 may receive, or otherwise gather, customer characteristic data and use those characteristics during the agent matching process, but not store the customer characteristic data in a long-term storage database.

Still referring to FIG. 1, the agent database 18 contains information regarding individual agents of the call center 10. As is to be appreciated, while depicted as a separate unit, the storage structure of the agent database 18 may be combined with the storage structure of the customer database 20, or any other hardware or software associated with the call center 10. Generally, the agent database 18 contains information related to the success of the agents 12, 14, 16 in converting customers based on individual characteristics of the customer. The agent database 18 may comprise a caller conversion success profile 30 associated with each agent 12, 14, 16 in the call center 10. The caller conversion success profile 30 may contain data regarding the agent's aptitude and success with customers having various traits or characteristics. For example, an individual agent will likely have a higher degree of success with customers having certain characteristics or combination of characteristics. Some agents may be quite successful in generating sales, or otherwise satisfying a goal or set of goals, with customers from specific geographic locations while other agents are skillful in converting customers with certain occupations or income levels, or during calls at a particular time of day. This information may be stored in the agent database 18 and used by the matching application 22 when matching a customer to an agent. As is to be appreciated, the data associated with the caller conversion success profile 30 may depend on the particular application. For example, the data stored in the call conversion success profiles for a realtor will likely differ from the data stored in the call conversion success profiles for an on-line sales representative.

As indicated by feedback path 32, the information within the database 18 may be updated, either continuously or intermittently, based on the agents' recent sales calls (e.g., whether the agent converted calls from customers with certain characteristics or not). As is to be appreciated, an agent's caller conversion success profile 30 may change over time as the agent develops skills and approaches to interacting with the various customers. By updating the agent database 18 using the feedback path 32, the matching module 22 can use updated information, including real-time or near real-time information, to match the customer to the available agent with a high degree of correlation.

FIG. 2 is a flow chart 50 of a matching process implemented by the matching module 22 of FIG. 1 according to one non-limiting embodiment. The matching module 22 may use this matching process to pair a customer with an agent. At 52, customer data is collected. The customer data may contain variables related to the customers, such as age or gender, for example. At 54, the customer data is submitted to the call center. The customer data may be stored in the customer database 20 (FIG. 1). In some embodiments, the customer data is received by the matching module 22 and used to pair the customer with an agent, but the data is not stored in the database 20. Before placing an outgoing call to a particular customer from the call center, at 56, the variables available for the particular customer are identified. At 58, a computer system, executing the software of the matching module 22, may generate a prioritized list of agents based on the customer variables and the agent success data (stored in the agent database 18). The prioritized list may include all the presently available agents in the call center, or may be a finite number of the agents, such as the top twenty agents for the particular customer, for example. In some embodiments, the matching module 22 may compute one or more scores for the agents in order to generate the prioritized list. That is, the agents may be prioritized by score. According to various embodiments, the score(s) may be computed based on the agents' conversion data for each known characteristic of the customer. For example, the score may be an average of the agents' conversion scores for each known characteristic of the customer. In such embodiments, the conversion scores may be evenly or unevenly weighted.

At 60, the computer system determines if the highest agent on the list is available for a call with the customer. If that agent is available, at 62 the call to the customer is routed to that agent (such as by a private branch exchange). If the agent is not available, at 64 the computer system decrements to the next highest agent on the prioritized list to determine an alternate agent. If that alternate agent is available, at 68 the customer is routed to that agent. If the alternate agent is not available, the computer system progresses through the prioritized list until an available agent is identified. As it to be appreciated, when a customer is routed to an agent, any number of processes may take place. For example, the customer information may be loaded into the queue of an agent's autodialer or the computer system may telephonically connect the customer to the agent using an outbound call. Additionally, the allocation process may be used for incoming calls based on any customer data that is available upon receipt of the call. As such, the processes described herein are applicable to incoming calls from customers as well. Customer data for incoming calls may be ascertained from the customer before routing to a particular agent. For example, name and geographic information for the caller may be determined from a caller ID system. Additionally, the customer could answer or respond to a series of automated prompts, for example, in order to generate sufficient customer data to make a more informed allocation of the call to an agent.

In some embodiments, the prioritized list is a ranked list, while in other embodiments the prioritized list groups the agents into segments or buckets (e.g., the agents with the top “N” scores or all agents having a score greater than or equal to “x”). For example, based on the customer data, the computer system may determine that any agent in a first segment or bucket has a relatively high level of conversion correlation to the customer. If an agent in that first segment is not available, the system can progress to a second segment or bucket of agents. Thus, while the individual agents are not ranked, the segments are ranked in such an embodiment. In one embodiment, for each customer the agents are divided into quartiles, with priority given to agents in the top quartile. Only if there are no agents available in the top quartile does the system pair the customer with an agent in one of the lower quartiles.

A customer and an agent may come in contact through various channels. In one embodiment, a customer may visit a webpage and indicate that the customer wishes to converse with an agent about a particular service or product. The customer may then populate an on-line form with information, such as name and telephone number, and electronically transmit the form to the call center. The form may have a ‘call me now option’ preselected. The form may also include a calendaring functionality allowing the customer to schedule a call at a future date and time. Upon successful transmission of the form, the customer may be provided with an access code from the call center. The access code may be provided to the customer using any suitable technique, such as by displaying the access code on a webpage, sending the code via e-mail, or sending the code via a text message, for example. In one embodiment, the call center may use the allocation algorithm illustrated in FIG. 2 to match the customer to an agent based on the information supplied in the form. As discussed, above the agent may be any suitable representative, such as a realtor, a financial advisor, an insurance agent, or a sales agent, for example. For outgoing calls to the customer, an automated telephone system associated with the call center, may then dial the telephone number for the customer provided in the form. Upon answering the telephone, the customer may be asked to input the access code in order to verify the identify of the customer and reduce spurious connections. Once the customer has been verified, the telephone system of the call center may connect the selected agent to the call with the customer. As is to be appreciated, any suitable telephony network may be used, such as traditional telephone networks (e.g., public switched telephone network) or VOiP networks, for example. Additionally, the call center's telephone system may be implemented using any suitable telephony engine, such as ASTERISK® PBX, for example. In some embodiments, the customer may be connected directly to an agents mobile telephone, or other mobile computer device, such as a netbook or smartphone, using a voice and/or data network, for example,

In one embodiment, a customer submits information to the call center on an online form. The information on the form indicates various characteristics of the customer. For example, the customer may be a male from Seattle, Wash. with an annual income in the range of $50,000 to $55,000. This data would be utilized by the matching module 22 (FIG. 1) and compared against the available agents to determine which agent would be best suited to communicate with the customer. A first agent, for example, may have a 56% conversion success rate with male customers from Seattle having income in the range of $50,000 to $55,000. A second agent may have a 76% conversion success rate for such customers, and a third agent may have a 84% success rate. In accordance with one embodiment, the customer would be routed to the third agent. If the third agent was unavailable, the customer may be routed to the second agent, and so on.

In another embodiment, using a customer with the same characteristics as outlined above, a first agent may have a 79% conversion success rate with customers from Seattle while a second agent may have a 93% conversion success rate with customers having a salary in the range of $50,000 to $55,000. That second agent may have, however, only a 23% conversion success rate with customers from Seattle. Thus, in this example, the matching module may route the customer to the first agent.

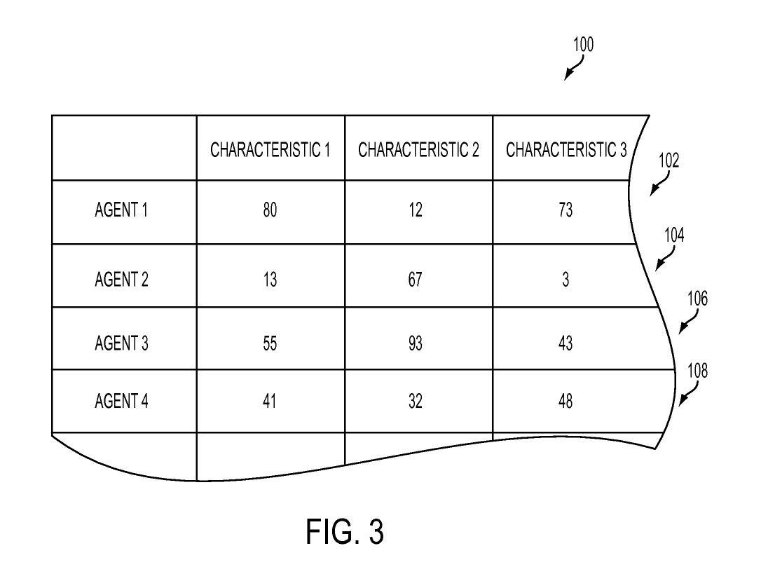

FIG. 3 is a table 100 comprising caller conversion success profiles in accordance with one non-limiting embodiment. The table 100 may be stored, for example, in the agent database 18. Each row in the table 100 may have conversion data for a particular agent. Each column in the table 100 may be related to a characteristic of the customer. As is to be appreciated, the particular arrangement of the table 100 may vary and the embodiments disclosed herein are not limited any particular arrangement. Furthermore, while three characteristics are included in table 100, it is to be appreciated that the number of characteristics for any particular implementation may vary. In some embodiments, for example, characteristic 1 may be related to a customer's gender, characteristic 2 may be related to a customer's income level, and characteristic 3 may be related to the customer's geographic location. The conversation data contained in the table 100 is representative of a conversion ratio, such that the data represents an agent's percentage of successful conversions with customers having a particular characteristic. For example, Agent 1 is 80% successful with customers having Characteristic 1. In other embodiments, other success metrics may be used as part of an agents caller conversion success profile.

Still referring to FIG. 3, a first caller conversion success profile 102 comprises the conversion data of Agent 1 for the various characteristics. A second caller conversion success profile 104 comprises the conversion data of Agent 2 for the various characteristics. A third caller conversion success profile 106 comprises the conversion data of Agent 3 for the various characteristics. A fourth caller conversion success profile 108 comprises the conversion data of Agent 4 for the various characteristics. While in the illustrated embodiment, data is available for each characteristic for each agent, it is to be appreciated that in some case no data may be available for a particular characteristic or agent. The data stored in table 100 may be updated based on the ongoing performance of the agents. The data may be updated during any suitable frequency, such as in “real time”, daily, weekly, monthly, or intermittently, for example. Furthermore, the type of information stored in the table 100 may depend on the desired goal(s) sought during interactions between and agent and a customer.

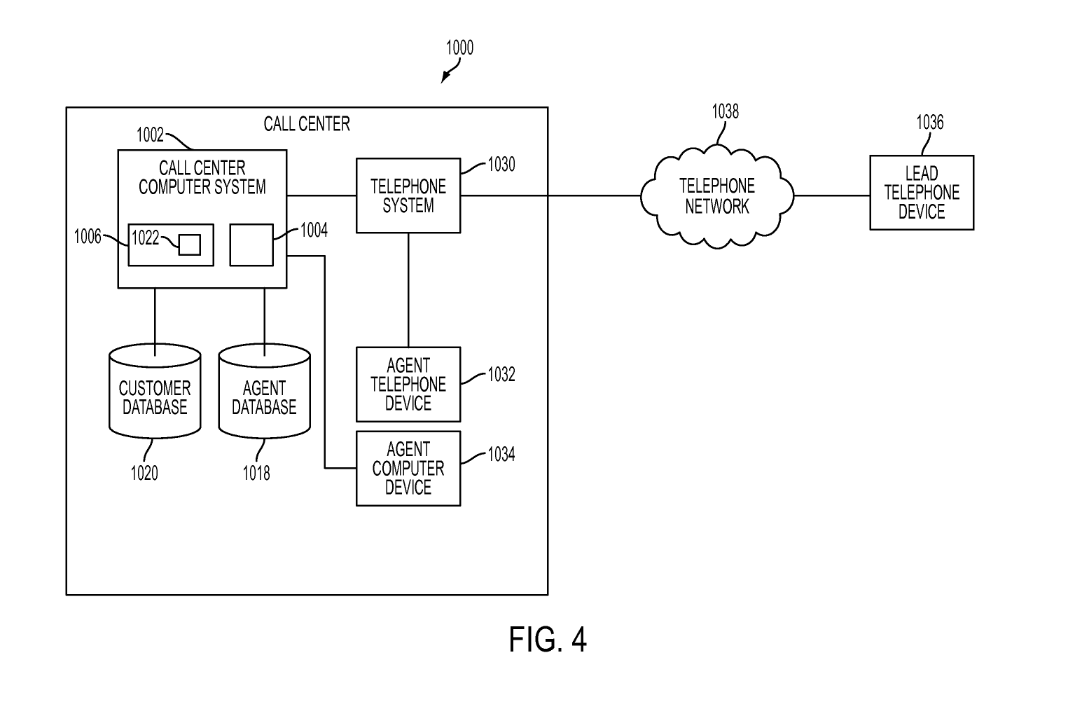

FIG. 4 is an illustration of a call center 1000 in accordance with one non-limiting embodiment. A call center 1000 may comprise a call center computer system 1002. The call center computer system 1002 may comprise one or more processor 1004 and a memory 1006 configured to store a matching application program 1022. The processor 1004 may comprise a processor integrated circuit, for example, having one or multiple cores. The memory 1006 may comprise various forms of memory circuits, such as volatile and non-volatile memory, for example. The volatile memory may comprise RAM, such as a RAM IC. The non-volatile memory may comprise ROM (such as a ROM IC), PROM (such as an EEPROM IC), a magnetic hard disk drive, and/or an optical disk drive, for example. Software with instructions for executing the matching application program 1022 may be stored on the memory associated with the computer device. The matching application program 1022 may use data stored in a customer database 1020 and an agent database 1018 as previously discussed. The processor 1004 of the computer device may execute the software to match a customer to an agent. The call center 1000 may further comprise a telephone system 1030 such as ASTERISK® PBX, for example. An agent telephone device 1032 may be in communication with the telephone system 1030 and an agent computer device 1034 may be in communication with the call center computer system 1002. As is to be appreciated, the call center 1000 may comprise a variety of other devices, networks, and paths of communication. The call center 1000 may be in communication with a customer telephone device 1036 via a telephone network 1038.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, user interface layouts, or screen displays described herein are necessarily intended to limit the scope of the invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused discussions would not facilitate a better understanding of the present invention, and therefore, a more detailed description of such elements is not provided herein.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

In various embodiments, modules or software can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Moreover, the processes associated with the present embodiments may be executed by programmable equipment, such as computers, or other processor-based devices. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

A “computer,” “computer system,” “host,” “engine,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, table layouts, or report formats described herein are necessarily intended to limit the scope of the invention.

In general, it will be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present invention. For example, the embodiments described hereinabove may be implemented in computer software using any suitable computer programming language or platform such as .NET, SQL, or HTML using, for example, conventional or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high-level languages include Ada, BASIC, C, C++, C#, COBOL, Fortran, Java, Lisp, Pascal, Object Pascal; and examples of scripting languages include Bourne script, JavaScript, Python, Ruby, PHP, and Perl. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Various embodiments of the systems and methods described herein may employ one or more electronic computer networks to promote communication among different components, to transfer data, or to share resources and information. Such computer networks can be classified according to the hardware and software technology that is used to interconnect the devices in the network, such as optical fiber, Ethernet, wireless LAN, HomePNA, power line communication or G.hn. The computer networks may also be embodied as one or more of the following types of networks: local area network (LAN), metropolitan area network (MAN), wide area network (WAN), virtual private network (VPN), storage area network (SAN), or global area network (GAN), among other network varieties.

For example, a WAN computer network may cover a broad area by linking communications across metropolitan, regional, or national boundaries. The network may use routers and/or public communication links. One type of data communication network may cover a relatively broad geographic area (e.g., city-to-city or country-to-country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link-layer protocols of the VPN can be tunneled through the other network. One VPN application can promote secure communications through the Internet. The VPN can also be used to separately and securely conduct the traffic of different user communities over an underlying network. The VPN may provide users with the virtual experience of accessing the network through an IP address location other than the actual IP address which connects the access device to the network.

The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods and systems described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity. As applied herein, an extranet may include a network or internetwork generally limited to a primary organization or entity, but which also has limited connections to the networks of one or more other trusted organizations or entities (e.g., customers of an entity may be given access an intranet of the entity thereby creating an extranet).

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs); remote bridges can be used to create a wide area network (WAN) link between LANs; and/or, wireless bridges can be used to connect LANs and/or to connect remote stations to LANs.

In various embodiments, a hub may be employed which contains multiple ports. For example, when a data packet arrives at one port of a hub, the packet can be copied unmodified to all ports of the hub for transmission. A network switch or other devices that forward and filter OSI layer 2 datagrams between ports based on MAC addresses in data packets can also be used. A switch can possess multiple ports, such that most of the network is connected directly to the switch, or another switch that is in turn connected to a switch. The term “switch” can also include routers and bridges, as well as other devices that distribute data traffic by application content (e.g., a Web URL identifier). Switches may operate at one or more OSI model layers, including physical, data link, network, or transport (i.e., end-to-end). A device that operates simultaneously at more than one of these layers can be considered a multilayer switch. In certain embodiments, routers or other like networking devices may be used to forward data packets between networks using headers and forwarding tables to determine an optimum path through which to transmit the packets.

As employed herein, an application server may be a server that hosts an API to expose business logic and business processes for use by other applications. Examples of application servers include J2EE or Java EE 5 application servers including WebSphere Application Server. Other examples include WebSphere Application Server Community Edition (IBM), Sybase Enterprise Application Server (Sybase Inc), WebLogic Server (BEA), JBoss (Red Hat), JRun (Adobe Systems), Apache Geronimo (Apache Software Foundation), Oracle OC4J (Oracle Corporation), Sun Java System Application Server (Sun Microsystems), and SAP Netweaver AS (ABAP/Java). Also, application servers may be provided in accordance with the .NET framework, including the Windows Communication Foundation, .NET Remoting, ADO.NET, and ASP.NET among several other components. For example, a Java Server Page (JSP) is a servlet that executes in a web container which is functionally equivalent to CGI scripts. JSPs can be used to create HTML pages by embedding references to the server logic within the page. The application servers may mainly serve web-based applications, while other servers can perform as session initiation protocol servers, for instance, or work with telephony networks. Specifications for enterprise application integration and service-oriented architecture can be designed to connect many different computer network elements. Such specifications include Business Application Programming Interface, Web Services Interoperability, and Java EE Connector Architecture.

In various embodiments, computers and computer systems described herein may have the following main components: arithmetic and logic unit (ALU), control unit, memory, and input and output devices (I/O devices). These components can be interconnected by busses, often comprising groups of wires or cables. The control unit, ALU, registers, and basic I/O (and often other hardware closely linked with these sections) can be collectively considered a central processing unit (CPU) for the computer system. The CPU may be constructed on a single integrated circuit or microprocessor.

The control unit (control system or central controller) directs the various components of a computer system. The control system decodes each instruction in a computer program and turns it into a series of control signals that operate other components of the computer system. To enhance performance or efficiency of operation, the control system may alter the order of instructions. One component of the control unit is the program counter, a memory register that tracks the location in memory from which the next instruction is to be read.

The ALU is capable of performing arithmetic and logic operations. The set of arithmetic operations that a particular ALU supports may be limited to adding and subtracting or might include multiplying or dividing, trigonometry functions (sine, cosine, etc.) and square roots. Some may be programmed to operate on whole numbers (integers), while others use floating point to represent real numbers, for example. An ALU may also compare numbers and return Boolean truth values (e.g., true or false). Superscalar computers may contain multiple ALUs to facilitate processing multiple instructions at the same time. For example, graphics processors and computers with SIMD and MIMD features often possess ALUs that can perform arithmetic operations on vectors and matrices. Certain computer systems may include one or more RAM cache memories configured to move more frequently needed data into the cache automatically.

Examples of peripherals that may be used in connection with certain embodiments of the invention include input/output devices such as keyboards, mice, screen displays, monitors, printers, hard disk drives, floppy disk drives, joysticks, and image scanners.

Embodiments of the methods and systems described herein may divide functions between separate CPUs, creating a multiprocessing configuration. For example, multiprocessor and multi-core (multiple CPUs on a single integrated circuit) computer systems with co-processing capabilities may be employed. Also, multitasking may be employed as a computer processing technique to handle simultaneous execution of multiple computer programs.

In various embodiments, the systems and methods described herein may be configured and/or programmed to include one or more of the above-described electronic, computer-based elements and components. In addition, these elements and components may be particularly configured to execute the various rules, algorithms, programs, processes, and method steps described herein.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as set forth in the appended claims.

What is claimed is:

1. A method, comprising:
receiving by a computer system customer information about a customer, wherein the customer information comprises a first characteristic of the customer and a second characteristic of the customer;
storing agent information about a plurality of agents in an electronic database, wherein the agent information comprises a caller conversion success profile for each of the plurality of agents;
determining by the computer system a prioritized list of agents for communicating with the customer, wherein the prioritized listed is based on factors comprising the first and second characteristics of the customer and the caller conversion success profiles, and wherein the prioritized list comprises a plurality of agents;
determining by the computer system whether an agent with a highest priority on the prioritized list is available to communicate with the customer; and
connecting a telephony call between the customer and the available agent with the highest priority when the agent with the highest priority is available.

2. The method of claim 1, wherein the caller conversion success profiles for the agents indicate historical conversion rates based on factors comprising the first and second characteristics.

3. The method of claim 1, wherein connecting the telephone call between the customer and the available agent comprises connecting the customer to a mobile device associated with the available agent.

4. The method of claim 1, further comprising determining by the computer system whether a next highest agent on the prioritized list is available to communicate with the customer when the agent with the highest priority on the prioritized list is not available to communicate with the customer.

5. The method of claim 1, wherein the first characteristic is the customer's gender and the second characteristic is the customer's age.

6. The method of claim 1, wherein the first characteristic is a characteristic selected from the group consisting of time of day, income level, and geographic area.

7. The method of claim 1, wherein connecting the customer to the agent with the highest priority comprises a telephony engine dialing a phone number supplied in the customer information.

8. The method of claim 1, further comprising storing the customer information in an electronic database.

9. A system, comprising:
a call center for handling calls for a plurality of agents;
an agent database comprising a plurality of agent caller conversion success profiles for the agents of the call center; and
a computer system programmed to match a customer of the call center to one of the plurality of agents based on the agents' caller conversion success profiles and characteristics of the customer.

10. The system of claim 9, wherein the plurality of agents includes at least one agent in a remote location.

11. The system of claim 9, wherein the customer is associated with at least one profile variable, and wherein the computer system matches the customer to one of the plurality of agents based on factors comprising the at least one profile variable and the agents' caller conversion success profiles.

12. The system of claim 10, wherein the at least one profile variable is a profile variable selected from the group consisting of age, income, gender, and geographic location.

13. A method, comprising:
storing customer information about a customer in an electronic database, wherein the customer information comprises a first characteristic of the customer and a second characteristic of the customer;
storing agent information about a plurality of agents in an electronic database;
determining by a computer system an agent for communicating with the customer, wherein the determination is based on factors comprising (1) the first and second characteristics of the customer, and (2) the agent information; and
connecting a telephony call between the customer and the agent.

14. The method of claim 13, comprising:
determining by the computer system whether the agent is available to communicate with the customer; and
when the agent is not available, determining by the computer system an alternate agent to communication with the customer, wherein the determination of the alternate agent is based on the first and second characteristics and the agent information.

15. The method of claim 14, comprising:
determining by the computer system whether the alternate agent is available to communicate with the customer; and
connecting a telephony call between the customer and the alternate agent when the alternate agent is available.

16. The method of claim 13, wherein storing agent information about a plurality of agents comprises storing a caller conversion success profile for each of a plurality of agents.

17. The method of claim 16, further comprising updating the caller conversion success profiles based on the agents' performance.

18. The method of claim 13, further comprising:
determining by the computer system a prioritized list of agents for communicating with the customer, wherein the prioritized listed is based on factors comprising the first and second characteristics, and wherein the prioritized list comprises a plurality of agents.

19. The method of claim 13, wherein one of the first characteristic and second characteristic is a characteristic selected from the group consisting of gender, occupation, geographic location, and income level.

20. The method of claim 13, wherein connecting the customer to the agent comprises a telephony engine dialing a phone number supplied in the customer information.
